(19) United States
(12) Patent Application Publication
(10) Pub. No.: US 2024/0384374 A1
(43) Pub. Date: Nov. 21, 2024

(54) CU-ZN-ALLOY

(71) Applicant: OTTO FUCHS - KOMMANDITGESELLSCHAFT, Meinerzhagen (DE)

(72) Inventors: Björn Reetz, Krefeld (DE); Tileman Münch, Viersen (DE); Thomas Plett, Schmallenberg (DE)

(21) Appl. No.: 18/663,407

(22) Filed: May 14, 2024

(30) Foreign Application Priority Data
May 17, 2023 (EP) 23173883.2

(51) Int. Cl. C22C 9/04

(52) U.S. Cl. CPC C22C 9/04

(57) ABSTRACT

A Cu—Zn alloy is described with (in % by weight):
Cu: 60.5-65.5%
Si: 1.1-1.7%
Mn: 2.51-2.9%
Ni: 0.15-0.55%
Fe: 0.02-0.12%
P: 0.26-0.39%
Cr: 0.018-0.12%
Al: max. 0.3%
Sn: max. 0.3%
Pb: max. 0.1%
Zn: remainder
together with unavoidable impurities, which do not exceed 0.1% per element and 0.3% in total. An alloy product manufactured from such an alloy, a process for manufacturing such an alloy product, and a use thereof are also described.

### RELATED APPLICATION

This application claims priority to European patent application EP 23143883.2 filed May 17, 2023, which is incorporated-by-reference herein.

### BACKGROUND

The disclosure relates to a lead-free Cu—Zn alloy, an alloy product manufactured therefrom, and process for manufacturing such an alloy product.

High-tensile brass alloys having a plurality of different alloy compositions are known from the prior art. These alloys are used for different purposes. In addition to the main elements Cu and Zn, high-tensile brass alloys comprise other elements through which the desired alloy properties can be adjusted. This also includes the structure that can be achieved with it. The structure of the alloy product is largely responsible for certain properties of the alloy product, for example its processability, such as hot forming. For hot forming, it is preferred that the brass alloy has a dominant β phase. The main reason for the good hot formability of the β phase at higher temperatures is an easier activation of the sliding systems within the microstructure of the alloy as a carrier of the plastic deformation, and a low level of hot hardening. In simple terms, this results in higher ductility and lower hardness of the β phase during hot forming. A certain share of α phase is tolerable. However, efforts are made to avoid the formation of a γ phase in hot-formable high-tensile brass alloys, as this phase is brittle and thus has a negative impact on the desired hot-forming properties.

A problem with multi-component alloys, especially those that contain several alloying elements in addition to Cu and Zn, is that due to the complex interaction between the individual alloy components, a change in a single component can lead to unforeseeable changes to the alloy product. Changing several alloy components in an alloy can lead to even more unpredictable results.

For components subject to sliding stress, lead-reduced or lead-free Cu—Zn alloys have been proposed, which have phase precipitates in the form of manganese silicides. These precipitates provide the alloy product with high resistance to abrasive wear and reduce the tendency to local adhesion to the sliding surfaces. Such alloys often have a structure with a predominantly ß phase or a heterogeneous matrix with α and ß phases.

However, a high share of ß phase has a disadvantageous effect on the cold formability of a Cu—Zn alloy. To address this problem, DE 10 2007 029 991 B4 proposes to form the alloy product with a structure in which iron and nickel-containing manganese silicides are present and which has an a matrix in which 5% to 50% by volume (vol %) of ß phase is embedded. The alloy composition consists of 28-36% by weight Zn, 0.5-1.5% by weight Si, 1.5-2.5% by weight Mn, 0.2-1.0% by weight Ni, 0.5-1.5% by weight Al, 0.1-1.0% by weight Fe, and the remainder Cu.

EP 3 272 888 A1 discloses a brass alloy product that enables high degrees of cold forming without intermediate annealing. An alloy composition of 21-27% by weight Zn, 0.2-0.8% by weight Si, 1.1-1.9% by weight Mn, and 0.005-0.2% by weight P results in an a-matrix in which manganese-containing phosphides are present with a string-of-pearl arrangement.

DE 36 26 435 A1 discloses a Cu—Zn alloy with 66-90% by weight Cu, 1.5-8.0% by weight Mn, 0.3-7.0% by weight Al, 0.3-2.0% by weight P, and the remainder Zn. With a sufficiently high share of aluminum, manganese phosphides that act as wear reducers are substantially present in a eutectic distribution within an a-matrix, which are smaller than primarily precipitated phosphides and therefore do not negatively impact cold formability.

WO 2015/046421 A1 discloses a discoloration-insensitive copper alloy with 17-34% by weight Zn, 0.005-1.8% by weight Al, 0.01-1.5% by weight Mn, 0.01-5% by weight Ni, 0.01-1.0% by weight Si, 0.005-0.9% by weight P, 0.01-2.5% by weight Sn, 0.0005-0.0030% by weight Pb, and the remainder Cu. The structure of this alloy is α phase dominant and contains small shares of β phase and γ phase. The area of application of this alloy is aimed at color stability.

JP S62274036 A discloses a Cu—Zn alloy with high wear and corrosion resistance. This alloy has the following composition (in wt %): Cu 37.7-89.7%, Si 0.05-3.0%, Mn 0.1-6.0%, P 0.005-0.10%, Al 0.05-1.0%, Sn 0.05-1.0%, the remainder Zn. Ni, Fe, Cr and/or Pb can be added to the alloy as mandatory alloy components in shares of 0.005-2.0% by weight.

An alloy product manufactured from a lead-free Cu—Zn alloy is known from EP 3 992 319 A1. This alloy or alloy product manufactured therefrom is characterized by special phase precipitations for a wide process range with simplified adjustability. The alloy product has good corrosion resistance and good machinability.

The requirements for Cu—Zn alloys or alloy products manufactured therefrom can be very complex. A particularly complex requirement profile for the Cu—Zn alloy or alloy product manufactured therefrom exists when it is designed to be subject to sliding stress in an oil environment, through which transverse forces are introduced into the sliding surfaces due to dynamic loads. For example, such an application of a sliding part, typically designed as a sliding shoe, occurs when the sliding part is part of an articulated joint, for example a ball joint, and forms the part of the articulated joint which receives the swivel head as a joint partner of another part. The requirements placed on such a sliding part not only concern special wear resistance and compatibility with lubricants, even when using different lubricants, especially those with additives, but also sufficient fatigue strength and a sufficient plastic deformation reserve to avoid stress fractures. If the articulated joint, in particular if embodied as a ball joint, is part of an axial piston machine, such as an axial piston pump or an axial piston motor, which axial piston machine is typically designed as a swash plate or inclined axis, there are also corresponding requirements for the sole of the sliding shoe, with which it is supported on a swash plate and is moved due to the adjustment of the swash plate relative to it. In addition, good machining and formability properties and sufficiently high strength are required. The alloy should also be inexpensive to manufacture.

Foregoing examples of related art and limitations therewith are intended to be illustrative and not exclusive. Other limitations will become apparent to those skilled in the art upon a reading of the specification and a study of the drawings. The following embodiments and aspects thereof are described and depicted in conjunction with systems, tools, and methods which are meant to be illustrative, not limiting in scope. Some embodiments may be directed to reducing or eliminating one or more problems, while other embodiments may be directed to other improvements SUMMARY

Proceeding from this background, one aspect of the disclosure is to propose a Cu—Zn alloy that is suitable for the manufacture of such products. This is provided according to the disclosure by a Cu—Zn alloy with (in % by weight or wt %):
Cu: 60.5-65.6%
Si: 1.1-1.7%
Mn: 2.51-2.9%
Ni: 0.15-0.55%
Fe: 0.02-0.12%
P: 0.26-0.39%
Cr: 0.018-0.12%
Al: max. 0.3%
Sn: max. 0.3%
Pb: max. 0.1%
Zn: remainder
together with unavoidable impurities, which do not exceed 0.1% per element and do not exceed 0.3% in total.

This alloy meets the complex requirements in order to be able to produce an alloy product that meets complex requirement profiles, in particular those that are required for a sliding shoe as part of an articulated joint in an oil environment.

The fact that this alloy also meets complex requirement profiles is due to the special interaction of the elements involved in the structure of the alloy, in particular the special Mn, P and Cr contents in combination with the Si content and the only small contribution of other elements to the structure of the alloy. The share of Fe is deliberately kept very low. The Si content is limited to a narrow range. By limiting the Fe and Si content, silicides form as hard phases, but not to an excessive extent. The share of Fe is also kept low so that, given the P content of the alloy, iron phosphides that are too coarse are not formed. Due to the Si content, silicides form as hard phases with a share of no more than 3-6% by volume. Although a higher share of silicides would improve the wear resistance of an alloy product used, for example, as a sliding shoe as part of an articulated joint, it would, however, under certain circumstances, increase wear on the surface of the swivel head interacting with the sliding shoe, which in turn is not desirable in such an application. The silicides are typically present in two fractions. A coarser fraction is regulated in the pressing direction and has grain sizes of 15-20 μm. As the other fraction, the relatively large number of finely divided silicides are primarily responsible for wear resistance. These finely divided silicides have grain sizes with a maximum of 1 μm and are found in the β phase, which is homogeneously distributed in the structure. The share of the β phase in the alloy is typically between 17 and 30%.

The Si content is adjusted in relation to the share of the alloy of other silicide-forming elements such that a certain share of free Si remains in the matrix. This has a favorable effect on the formation of a passivation layer if the alloy product is used in an oil environment, in particular an oil environment with additive or synthetic low-friction oils. In this high-tensile brass alloy, Mn is, along with Cu and Zn, an essential element in terms of its share. Mn increases strength. However, it has been shown that a higher Mn content leads to a reduction in elongation at break. The Mn content is therefore limited to a maximum of 2.9% by weight. The elements Al and Sn, which are typically mandatory alloy components in conventional alloys of this type, are not used in this Cu—Zn alloy, but are tolerated up to a maximum share of 0.3% by weight. Typically, the maximum share of the elements Al and Sn is 0.1% by weight. In conventional high-tensile brass alloys, Al is used alone or together with Ni in a significantly higher share than permitted in this high-tensile brass alloy in order to achieve the desired high strength. It was all the more surprising that the required strengths were achieved with the disclosed Cu—Zn alloy, even without Al being involved and even though Ni only plays a small part in the structure of the alloy.

It should also be emphasized that the alloy according to the disclosure only has a relatively small number of mandatory alloying elements, which simplifies processability and reduces the entry of contamination through carryover in the casting. It was not foreseeable that with a Cu—Zn alloy with such a simple alloy structure, this alloy or alloy product manufactured therefrom would still meet a very complex requirement profile, such as is required for sliding parts, such as sliding shoes as part of an articulated joint for example.

This alloy can be manufactured inexpensively. An alloy is generally considered inexpensive if its Cu content is kept low and the requirements to be achieved with the alloy are achieved using cheaper accompanying elements. This can be expressed via the Zn equivalent with the Guillet factors. In this way, the Cu content of the alloy can be limited. Preferably, Cu contributes no more than 64% by weight to the structure of the alloy.

A peculiarity of this alloy is that, without having to take any special steps when manufacturing the alloy product, the alloy or alloy product manufactured therefrom has a hardness sufficient for the purposes mentioned, a yield strength and tensile strength that meets the requirements and still has sufficient elongation at break. For example, in order to meet the requirement profile for a sliding shoe as part of an articulated joint, maximum values for the yield strength, tensile strength and hardness are not desired, since in such a case the alloy product would not have sufficient fatigue strength in cases of dynamic load. An elongation at break A5 of at least 11% satisfies the relevant requirements. The elongation at break A5 is typically between 8-15%.

Furthermore, this alloy has sufficient cold formability to be able to cold draw extruded rods manufactured as a preliminary product. This allows mechanical characteristics to be increased. In addition, the cold drawing process improves the straightness of the rod, which is positive for a subsequent shaping machining process. The cold formability of this alloy can also be used to cold form an alloy product manufactured therefrom in whole or in part, for example to enclose a ball head of a ball joint in the complementary ball joint receptacle by appropriate flanging of the upper edge section of the ball joint receptacle.

Interestingly, this alloy also has good machinability. The phosphides that form in the structure due to the P content, as well as the Cr content, promote machining. The strength properties of the alloy or alloy product manufactured therefrom are not chosen to be too high so that the joint partners can adjust or run in during an initial operating phase. Furthermore, this alloy meets the requirements for sufficient relaxation strength. The wear resistance is provided by the hard phases that form as a result of the alloy composition, in particular silicides, which are homogeneously distributed in the structure. A share of hard phases or the share of intermetallic phases of 2-6% by volume in the structure ensures wear resistance. Furthermore, the structure of this alloy or alloy product manufactured therefrom is α phase dominant. The structure typically comprises only 10-30% by volume of β phase. In addition to the hard phases, the rest of the structure is formed by α phase, with further phases with a share of max. 2% by volume, preferably not more than 1% by volume can be present at minor levels not affecting the properties of the alloy. These include, above all, the finer structural components that are not visible under the light microscope, which are typically precipitates with a size of less than 1 μm.

The reserve for plastic deformation and thus also for the safety against component breakage due to fatigue can be expressed via the yield to tensile strength ratio. The yield to tensile strength ratio Rp0.2/Rm is therefore between 70% and 78%. The flexural fatigue strength, which is more than 185 MPa for the alloy according to the disclosure, is also essential for the alloy or alloy product. 107 load cycles are used to test the flexural fatigue strength. The electrical conductivity of the alloy is between 9 and 16 mS/m.

The fine-grained structure of the disclosed alloy should also be highlighted. A sufficiently fine structure has a positive influence on the relaxation resistance, the strength, especially the fatigue strength, other mechanical characteristics, the surface quality and machining properties. A fine-grained structure is expedient for all of these factors. The hardness HBW in the finished part is in the range from 160 to 190, with the upper limit preferably being HBW 210.

Even if the above-described positive properties of this Cu—Zn alloy can be observed across the entire range of elements involved in the structure of the alloy, the complex requirement profile placed on this alloy will be further sharpened with the following compositions (in % by weight):
Cu: 60.5-65.5%
Si: 1.15-1.6%
Mn: 2.58-2.78%
Ni: 0.2-0.5%
Fe: 0.03-0.11%
P: 0.26-0.39%
Cr: 0.025-0.095%
Al: max. 0.1%
Sn: max. 0.1%
Pb: max. 0.1%
Zn: remainder
together with unavoidable impurities, which do not exceed 0.1% per element and do not exceed 0.3% in total.

Especially if the alloy has the following composition (in % by weight):
Cu: 62-64.2%
Si: 1.15-1.6%
Mn: 2.58-2.78%
Ni: 0.25-0.45%
Fe: 0.035-0.095%
P: 0.26-0.39%
Cr: 0.025-0.095%
Al: max. 0.1%
Sn: max. 0.1%
Pb: max. 0.1%
Zn: remainder
together with unavoidable impurities, which do not exceed 0.1% per element and do not exceed 0.3% in total.

Especially if the alloy has the following composition (in % by weight):
Cu: 62.5-64%
Si: 1.25-1.5%
Mn: 2.58-2.78%
Ni: 0.25-0.45%
Fe: 0.04-0.09%
P: 0.26-0.39%
Cr: 0.025-0.095%
Al: max. 0.1%
Sn: max. 0.1%
Pb: max. 0.1%
Zn: remainder
together with unavoidable impurities, which do not exceed 0.1% per element and do not exceed 0.3% in total.

Especially if the alloy has the following composition (in % by weight):
Cu: 63-63.5%
Si: 1.3-1.4%
Mn: 2.6-2.7%
Ni: 0.3-0.4%
Fe: 0.05-0.08%
P: 0.3-0.35%
Cr: 0.05-0.08%
Al: max. 0.1%
Sn: max. 0.1%
Pb: max. 0.1%
Zn: remainder
together with unavoidable impurities, which do not exceed 0.1% per element and do not exceed 0.3% in total.

Preferably, the unavoidable impurities are tolerated more narrowly such that they do not exceed 0.05% per element and do not exceed 0.2% in total.

The alloy or alloy product is manufactured using generally common process steps. This means that it is not necessary to use special process steps to achieve the desired alloy properties. The alloy can be manufactured as follows: The alloy is cast in a first step, preferably with a casting temperature between 980° C. and 1,100° C., preferably between 1,000° C. and 1,050° C. The alloy casting is then extruded in a temperature window between 720° C. and 780° C., preferably between 730° C. and 760° C. A round rod is typically what is extruded. In a subsequent step, the extruded rod is cold-drawn. In this cold-drawn state, the rod as a semi-finished product for manufacturing alloy products, for example sliding shoes as part of an articulated joint, has its highest mechanical strength values, but only a relatively low elongation at break. These first process steps are common steps for manufacturing a semi-finished product from which the actual high-tensile brass alloy products are manufactured.

To produce an alloy product, a forging can also be used as the starting product. This can then be annealed (heat treated). If necessary, after the heat treatment step, an intermediate step for straightening the forged alloy products must be carried out if, for example in the case of plates, the flatness of the same deviates too far from the specifications. The alloy product is then annealed (heat treated) again. The alloy product can also be cold formed for other purposes after the forging step, e.g. for the purpose of embossing, and then annealed for relaxation. A forged part has the same advantages as an alloy product that has been manufactured from an extruded rod section.

After cold drawing, in order to adjust the special characteristic strength values, the cold drawn rod, which has been straightened by cold drawing, is thermally relaxed in a temperature window of 380° C.-420° C. for 180-280 min, followed by cooling in ambient air. The above information relates to carrying out this process in a chamber furnace. In a continuous oven, the same results can be achieved in a shorter time, in just 20 to 30 minutes. This slightly reduces the strength achieved by cold drawing in terms of yield strength, tensile strength and hardness, but at the same time significantly increases the relatively low elongation at break of the cold-drawn rod. The fact that this is achieved to the required extent through such thermal treatment is due to the special alloy composition. This thermal treatment is also responsible for the formation of the fine-grained silicides already mentioned above. The mechanical characteristics of the rod achieved in this way not only meet the requirements profile for a sliding shoe to be manufactured as an alloy product as part of an articulated joint, but also for the further processing of this rod as a semi-finished product for manufacturing the desired alloy products, in particular its machinability.

The mechanical characteristics after the final thermal treatment of the extruded and subsequently cold-drawn rod with a forming of 20% based on the reduction in cross-sectional area and thus of the finished part are in the value ranges specified below:
Yield strength Rp0.2: 430-560 MPa, especially 430-500 MPa;
Tensile strength Rm: 570-670 MPa, especially 570-630 MPa;
Elongation at break A5: 8-11%; and
Hardness: HBW 165-205, especially 165-195.

The mechanical characteristics can be easily influenced by cold forming. If the mechanical characteristics of the alloy product are to be lower, the cold forming is carried out with lower forming, for example with only 10%.

After a section of such a rod has been cut to length, it is machined into the desired shape, for example in the shape of a sliding shoe as part of an articulated joint. If the alloy product is a sliding shoe as part of an articulated joint, this comprises the outer and inner contouring and thus also the formation of a swivel head mount into which the swivel head of the joint partner is inserted, for example as part of a piston. The increased elongation at break caused by the thermal treatment makes it possible for the alloy product to be plastically cold deformed in order to be able to enclose a swivel head inserted into the swivel head mount in a form-fitting manner. For this purpose, the swivel head mount of the sliding shoe is preferably embodied at a height such that it overlaps the apex of the swivel head. For the form-fitting connection of these two joint partners, the mouth edge region of the swivel head mount can then be cold-formed, for example flanged, so that it not only extends over the swivel head in terms of its height, but also physically, forming an undercut, so that the swivel head is then caught in a form-fitting manner within the swivel head mount. This cold deformation of the mouth edge region of the swivel head mount has the advantage that no additional parts are then required for the required connection of the two joint partners.

Furthermore, it is advantageous that the mouth edge region of the swivel head mount has undergone cold hardening as a result of this plastic cold deformation, so that the formed section or sections of the mouth edge region of the swivel head mount provide an increased moment of resistance as a swivel head enclosure, so that the swivel head accommodated therein is held securely in the swivel head mount even under dynamic loads. Also, due to this cold hardening, less material is required to provide the swivel head enclosure described above. Such a configuration is therefore particularly suitable for applications that require little space.

The disclosed alloy is lead-free. A maximum content of 0.1% by weight of Pb is tolerated.

In addition to aspects and embodiments described above, further aspects and embodiments will become apparent with reference to the drawings, wherein like reference numerals generally designate corresponding structures in the views.

### DESCRIPTION OF THE DRAWINGS

The following description includes reference to the drawings, wherein:

FIG. 1 is Table 1 which shows the alloy compositions of the samples tested,

FIG. 2 is Table 2 which shows test results for one set of samples,

FIG. 3 is Table 3 which shows test results for another set of samples,

FIG. 4 is Table 4 which shows test results for another set of samples,

FIG. 5 shows an example alloy product designed as a sliding shoe, in a schematic cross-sectional representation through an articulated joint between a sliding shoe with a swivel head mount and a swivel head of a joint partner inserted therein, before a form-fitting connection of the two joint partners, and

FIG. 6 shows the example alloy product of FIG. 5 after forming a form-fitting connection between the two joint partners.

Before explaining example embodiments, it is to be understood that the invention is not limited in application to the details of particular arrangements shown in the drawings, since the invention is capable of other embodiments. Embodiments and figures disclosed herein are to be considered illustrative rather than limiting.

### DETAILED DESCRIPTION

Studies were carried out on the Cu—Zn alloy according to the disclosure and compared with the results of comparison alloys. The samples examined were prepared as follows:
casting the respective alloy at a temperature of 1,010° C., which casting was carried out as a vertical continuous casting with a diameter of 290 mm;
extruding the alloy casting at a temperature of about 745° C., which extruded rod (solid material) has a diameter of 36.5 mm;
cold drawing the extruded rods to obtain a forming of 20% relative to the cross-sectional area of the extruded rod;
thermal treatment of the cold-drawn rod at about 395° C. for 220 min and then cooling in air;
cutting a test piece to length;
carrying out various tests on the cut sample to determine different characteristic values.

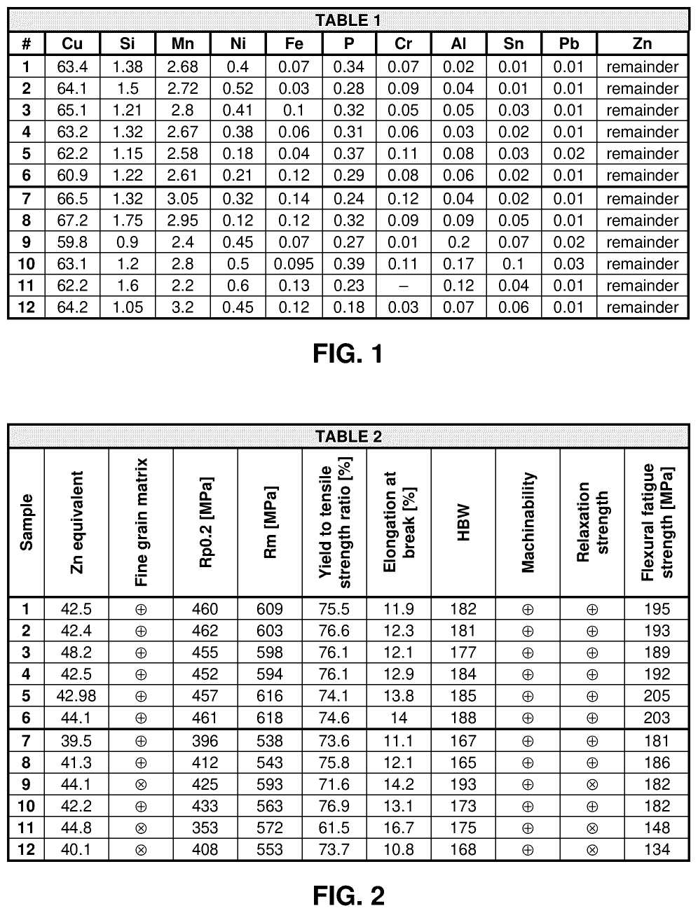

Table 1 (see FIG. 1) shows the alloy compositions of the samples tested, with samples 1 to 6 being Cu—Zn alloys according to the disclosure, and samples 7 to 12 being comparison alloys.

The alloys according to the disclosure have a hard phase share of 4.5-5.5%.

Overall, mechanical characteristics, such as yield strength Rp0.2, tensile strength Rm, elongation at break A5, yield to tensile strength ratio (quotient of yield strength Rp0.2 to tensile strength Rm) and the hardness HBW of the samples in the pressed state (after extrusion), have been determined after cold drawing and in the final state after thermal treatment. Furthermore, the structure in the final state of the samples (finished part) as well as the machinability as well as the relaxation strength and the flexural fatigue strength, which reflect information about the fatigue strength under dynamic cyclic load components, were examined. Results determined for the individual samples are shown in Table 2 (see FIG. 2).

The results of the finished part samples examined can be found in Table 2. In the tables, the information regarding machinability, relaxation strength and the fine grain size of the matrix are to be viewed as comparative studies, wherein a sample marked with the symbol ⊕ suffices for the respective purpose, while a sample marked with the symbol ⊗ does not meet the relevant requirement.

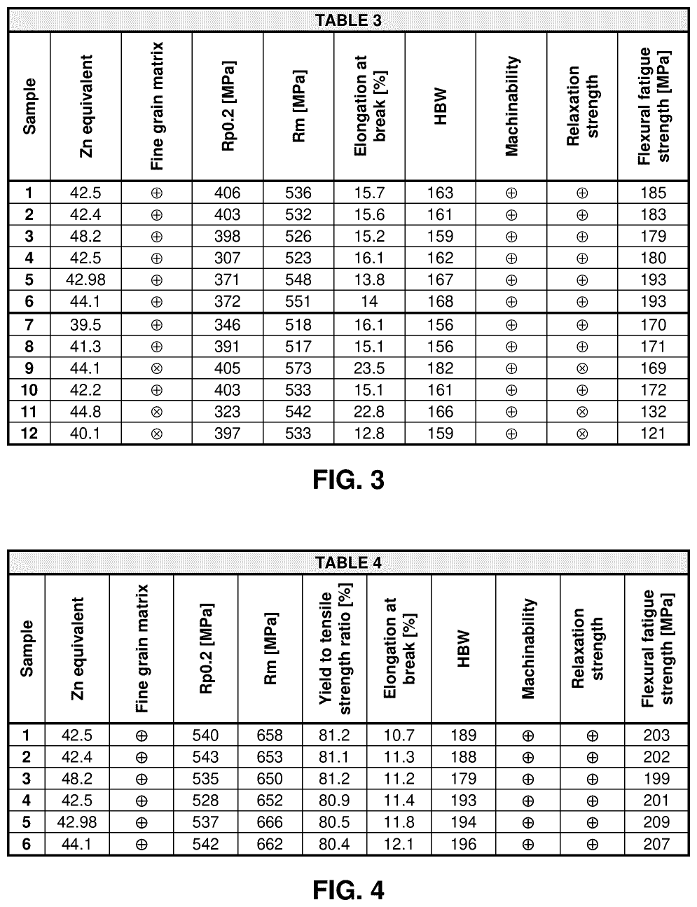

Samples were also manufactured from the same alloys and were subjected to cold drawing with only 10% forming. The mechanical characteristics determined for these samples are shown in Table 3 (see FIG. 3).

Sample pieces with a continuous casting diameter of 18 mm and a forming of 20% were also analyzed from the same alloys according to the disclosure. The strength values in this regard are, as expected, higher than the strength values of the samples above with the diameter of the extruded rod of 36.5 mm. These values are shown in Table 4 (see FIG. 4).

The flexural fatigue strength was tested based on 107 load cycles with the specified stress in accordance with ASTM E 466-15 (DIN 50100).

A comparison of the test results of the samples according to the disclosure (samples 1 to 6) with the reference alloy compositions (samples 7 to 12) shows that the latter do not meet the requirements in at least one of the properties examined. With regard to the flexural fatigue strength, the requirements are met if a sample with a stress of 170 MPa or more was subjected to the load cycle and no damage could be detected. As seen in the tables, the samples manufactured from the alloys according to the disclosure have a higher flexural fatigue strength. The requirement for the elongation at break A5 is 10% to 14%, so that those comparison samples that have too low or too high an elongation at break do not meet the relevant requirements. With regard to the yield to tensile strength ratio, a sample meets the requirements if it is at least 66% but not more than 83%. Since all samples were prepared using the same process, these differences are attributed to the different alloy compositions compared to the alloy compositions according to the disclosure.

All samples with the exception of samples 9 and 12 had sufficient lubricant compatibility and are therefore suitable for use in different oil environments without showing excessive susceptibility and thus increased wear.

Comparable test results, as shown for alloy products according to the disclosure, which were extruded after providing an alloy casting and then cold-formed, are achieved if a forged semi-finished product is manufactured by hot forging after providing an alloy casting. The forged semi-finished product can be a plate for example. The forged semi-finished product is then thermally relaxed, namely in a temperature window between 380° C. and 430° C. for 160 to 320 min. The thermal relaxation preferably takes place at around 385° C. for 220 min. This thermal relaxation can be carried out in a continuous furnace. Thermal relaxation is followed by cooling in still or moving ambient air. Finally, the alloy product (the forged semi-finished product) is shaped by machining.

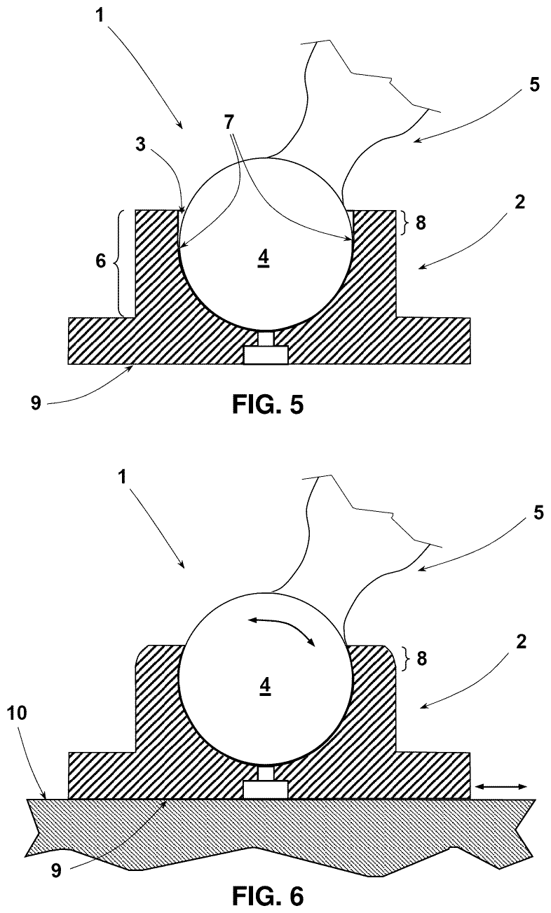

An example embodiment of an alloy product of the alloy according to the disclosure designed as a sliding shoe is now described with reference to FIGS. 5 and 6.

FIG. 5 shows a ball joint 1. This ball joint 1 is part of an axial piston pump designed as a swash plate or inclined axis pump. The ball joint 1 includes a sliding shoe 2. Sliding shoe 2 is supported with its sole 9 on a swash plate 10. Sliding shoe 2 can be moved relative to the swash plate 10 in the plane of its surface. Sliding shoe 2 was manufactured from the alloy of sample 4. After a piece of the extruded and thermally treated rod has been cut to length as a semi-finished product or preliminary product, this piece of rod has been brought into its shape shown in cross section in FIG. 6 by machining. In the example embodiment shown in the figures, this was done by dry or wet machining, for example by lathing. Sliding shoe 2 is rotationally symmetrical. As part of this machining, a swivel head holder 3 was also inserted into the semi-finished product. The bottom of swivel head mount 3 is hemispherically shaped and adapted to the curvature of the lateral surface of a swivel head 4 of the joint partner 5 inserted into swivel head mount 3. Swivel head 4 is a ball head. Joint partner 5 is a piston onto which swivel head 4 is molded. Height 6 of swivel head mount 3 is dimensioned such that it projects beyond apex 7 of swivel head mount 4 starting from the bottom of swivel head mount 3. In this section protruding beyond apex 7, swivel head mount 3 is initially cylindrical on the inside in order to be able to insert swivel head 4 into it for manufacturing ball joint 1. In the illustration of FIG. 5, swivel head 4 is not yet form-fittingly connected to sliding shoe 2.

The form-fitting connection of the two partners of ball joint 1 is shown in FIG. 6. This figure also shows the mobility of swivel head 4 relative to sliding shoe 2 and of sliding shoe 2 relative to swash plate 10.

For a form-fitting connection between sliding shoe 2 and swivel head 4, the cold deformability provided by the thermal treatment of the extruded rod is used and mouth edge region 8 of swivel head mount 3 is formed in the radial direction towards swivel head 4. The result of this cold forming is shown in FIG. 6. Mouth edge region 8 of swivel head mount 3 has been formed to form an undercut that extends over apex 7 of swivel head 4. As a result of this cold forming, mouth edge region 8 has undergone cold hardening, so that it is harder than the other components of sliding shoe 2. This cold hardening has the advantage that the physical extension over apex 7 by the forming process does not have to be excessively large in order to ensure a safe enclosure of swivel head 4 in swivel head mount 3, which is then closed by the formation of an undercut as a result of the forming.

The invention has been described in the context of example embodiments. Without departing from the scope of the claims, there are numerous other possibilities for a person skilled in the art to implement the invention, without these having to be explained or shown in more detail in the context of this disclosure. Accordingly, while several aspects and embodiments have been discussed herein, those persons skilled in the art will recognize numerous possible modifications, permutations, additions, combinations and sub-combinations therefor, without these needing to be specifically explained or shown within the context of this disclosure. The claims should therefore be interpreted to include all such modifications, permutations, additions and sub-combinations, which are within their true spirit and scope. Each embodiment described herein has numerous equivalents.

The terms and expressions which have been employed are used as terms of description and not of limitation, and there is no intention in the use of such terms and expressions of excluding any equivalents of the features shown or described, or portions thereof, but it is recognized that various modifications are possible within the scope of the invention. Thus, it should be understood that although the invention has been specifically disclosed by preferred embodiments and optional features, modification and variation of the concepts herein may be resorted to by those skilled in the art, and that such modifications and variations are considered to be within the scope of this invention as defined by the claims. Whenever a range is given in the specification, all intermediate ranges and subranges, as well as all individual values included in the ranges given are hereby incorporated into this disclosure. When a Markush group or other grouping is used herein, all individual members of the group and all combinations and sub-combinations possible of the group are hereby individually included in this disclosure. In general, the terms and phrases used herein have their art-recognized meaning, which can be found by reference to standard texts, references and contexts known to those skilled in the art. Any above definitions are provided to clarify their specific use in the context of the invention.

### LIST OF REFERENCE NUMERALS

1 Ball joint
2 Sliding shoe
3 Swivel head mount
4 Swivel head
5 Joint partner
6 Height of the swivel head mount
7 Vertex of the swivel
8 Mouth edge region
9 Sole
10 Swivel plate

1. A Cu—Zn alloy with (in wt %):
Cu: 60.5-65.5%
Si: 1.1-1.7%
Mn: 2.51-2.9%
Ni: 0.15-0.55%
Fe: 0.02-0.12%
P: 0.26-0.39%
Cr: 0.018-0.12%
Al: max. 0.3%
Sn: max. 0.3%
Pb: max. 0.1%
Zn: remainder
together with unavoidable impurities, which do not exceed 0.1% per element and do not exceed 0.3% in total.

2. The alloy of claim 1 with (in wt %):
Si: 1.15-1.6%
Mn: 2.58-2.78%
Ni: 0.2-0.5%
Fe: 0.03-0.11%
Cr: 0.025-0.095%.

3. The alloy of claim 2 with (in wt %):
Cu: 62-64.2%
Ni: 0.25-0.45%
Fe: 0.035-0.095%.

4. The alloy of claim 3 with (in wt %):
Cu: 62.5-64%
Si: 1.25-1.5%
Fe: 0.04-0.09%.

5. The alloy of claim 4 with (in wt %):
Cu: 63-63.5%
Si: 1.3-1.4%
Mn: 2.6-2.7%
Ni: 0.3-0.4%
Fe: 0.05-0.08%
P: 0.3-0.35%
Cr: 0.05-0.08%.

6. The alloy of claim 1, wherein a final state structure of the alloy has 15-40% by volume β phase, 1.5-5.5% by volume hard phases, remainder α phase, together with unavoidable further phases with a maximum share of 2% by volume.

7. The alloy of claim 6, wherein the share of β phase is 15-30% by volume and the share of hard phases is 2.5-3.5% by volume.

8. The alloy of claim 7, wherein the share of β phase is 15-25% by volume.

9. An alloy product manufactured from the alloy according to claim 1, wherein the alloy product has the following mechanical properties:
Yield strength Rp0.2: 300-560 MPa
Tensile strength Rm: 480-650 MPa
Elongation at break A5: 8-25%
Hardness: HBW 140-205.

10. The alloy product of claim 9, wherein the alloy product has the following mechanical properties:
Yield strength Rp0.2: 300-450 MPa
Tensile strength Rm: 480-550 MPa
Elongation at break A5: 8-18%
Hardness: HBW 140-170.

11. An alloy product manufactured from the alloy according to claim 1, wherein the alloy product is a sliding shoe formed from an extruded rod by machining.

12. The alloy product of claim 11, wherein the sliding shoe is connected in a form-fitting manner to a swivel head as part of a joint, wherein the sliding shoe has a swivel head mount and the swivel head is movably held in the swivel head mount with a form-fitting connection, the form-fitting connection provided by a cold deformation of a mouth edge region of the swivel head mount which extends at least in regions over the swivel head.

13. The alloy product of claim 12, wherein the sliding shoe with the swivel head inserted into the swivel head mount is designed as a ball joint.

14. The alloy product of claim 12, the mouth edge region is flanged to form the form-fitting connection with the swivel head.

15. A process for manufacturing an alloy product from the alloy according to claim 1,
comprising the steps:
providing an alloy casting,
extruding a rod from the alloy casting at a temperature between 720° C. and 780° C.,
cold forming the extruded rod by drawing with a deformation of 10-24%, based a cross-sectional region of the rod obtained by cold forming with respect to an initial cross-sectional region of the rod before cold forming,
thermally relaxing the cold-formed rod in a temperature window of 380° C.-430° C. for 160-320 min, which is followed by cooling in still or moving ambient air, and
shaping the alloy product by machining a section cut to length from the thermally relaxed rod.

16. The process of claim 15, wherein the alloy is cast at a temperature between 980° C. and 1,100° C.

17. A process for manufacturing an alloy product from the alloy according to claim 1,
comprising the steps:
providing an alloy casting,
hot forging the alloy casting to create a forged semi-finished product,
thermally relaxing the semi-finished product in a temperature window of 380° C.-430° C. for 160-320 min, which is followed by cooling in still or moving ambient air, and
shaping the alloy product by machining the semi-finished product.

18. The process of claim 17, further comprising, following the step of thermally relaxing, straightening the semi-finished product and then heat treating the semi-finished product.

19. The process of claim 17, wherein the alloy is cast at a temperature between 980° C. and 1,100° C.
